(19) United States
(12) Patent Application Publication
(10) Pub. No.: US 2008/0167931 A1
(43) Pub. Date: Jul. 10, 2008

(54) Community resource management systems and methods

(76) Inventors: Richard Allen Gerstemeier, Richmond, TX (US); Daniel Stephen White, Houston, TX (US)

Correspondence Address: Guy McClung, # 114, 5315-B F.M. 1960 Road West, Houston, TX, 77069-4410, US

(21) Appl. No.: 11/649,731

(22) Filed: Jan. 4, 2007

(51) Int. Cl. G05B 19/00

(52) U.S. Cl. 705/8

(57) ABSTRACT

Systems for management of community resources; in certain aspects community resources including community-wide resources and individual unit (home, business) resources of a plurality of individual units; management including real-time supervision, monitoring, adjusting, and control of any and all resources, control via network (wired or wireless).

### BACKGROUND OF THE INVENTION

1. Field of the Invention

The present invention is directed to managing the resources (e.g. facilities, utilities, apparatuses, devices, appliances and functions) of a multi-unit community, e.g., but not limited to, a multi-unit residential community or multi-unit small business master-planned community; and, in certain particular aspects, to providing individual, centralized, and remote control of such resources.

2. Description of Related Art

The prior art discloses a wide variety of resource management systems and methods; for example, and not by way of limitation, the systems, devices, apparatuses, and methods disclosed in U.S. Pat. Nos. 7,089,190; 5,761,083; 6,188,397; 6,466,971; 6,906,617; 6,874,691; 6,902,332; 6,384,737; 6,989,763; 7,039,575;5,761,083; 5,930,773; 7,053,767; 6,900,556; and in U.S. Patent Applications Publication Nos. 20020166125; 20060080408; and 20050096753—all of said patents and applications incorporated fully herein for all purposes.

A variety of individual functions, apparatuses, and devices common to each home in a multi-home community have in the past been controllable and accessible remotely by an individual homeowner. Also in the past there has been no community-wide control, supervision, or management of such individual functions, etc. In times of normal weather, normal power consumption, and non-emergency conditions, individual-based oversight and control has worked, although in many cases in a manner that is wasteful of time, effort, and power.

### BRIEF SUMMARY OF THE PRESENT INVENTION

The present invention, in at least certain aspects, provides systems and methods for community-wide management of both community resources and assets and resources and assets of individual units (e.g. homes and/or businesses) within the community. In certain particular aspects, such systems and methods include a central community management system that accesses community-wide assets (facilities, utilities, appliances, devices, functions, common assets) and also accesses assets of each home in the community (e.g. via a home controller system) and each individual resource in each home. Such systems and methods provide for both individual and community supervision, scheduling, monitoring, adjusting, restricting, limiting and control of individual resources with communication via a network, e.g., but not limited to, wired or wireless, public or private networks, and, e.g. the Internet. In certain aspects, community resource management also manages (and in some cases optimizes) the use of resources external to the community, e.g. energy, water, natural gas supplies, electricity, communications and data.

In certain aspects, the present invention discloses, a community based management system and, in certain particular aspects, establishes a new layer of control within a community which focuses on resource conservation and the use of renewable resources through the introduction of infrastructure in the community that is constantly monitored and controlled, e.g. by the home owner and/or by the community itself (e.g. via a developer, home owners association or third party infrastructure provider). In certain aspects, the resources managed include natural gas, electricity, potable and grey water supplies, drainage systems and water features, (e.g. fountains, waterfalls, ponds, etc.) as well as security, access, and monitoring/intervention and/or communication systems). In certain aspects the present invention provides community controllers which introduce various enablers and constraints on controllers in each individual unit, home or business and community center. In certain aspects a community according to the present invention has a uniform wiring plan (structured wiring plan) for each structure and facility with a standard wiring cabinet with standard controllers in conjunction with a consumer interface in the unit, home or business or community center. In certain aspects a community according to the present invention is a municipality, or a master planned community, e.g. with (but not limited to) five hundred homes or more.

The present invention discloses, in certain aspects, community systems for management of a plurality of community assets of a community and/or of unit assets of each of a plurality of individual units of a community, the systems having: a central control system in communication with each community asset for managing each community asset; each individual unit of the plurality of units of the community having a unit manager in communication with each unit asset for managing each unit asset; the central control system in communication with each unit manager for selective management of each unit asset by the central control system; and a network system providing for communications between the central control system and each unit manager and providing for communications between the central control system and each community asset.

Such systems and methods according to the present invention, in certain aspects, include individual power generation apparatuses and/or community power generation apparatuses which are supervised, etc. by the community management system. This system controls the power generation apparatuses in both normal and emergency conditions. In one particular aspect, in situations which are not emergency situations, the community management system controls individual power consumption to optimize both individual and community power consumption (power generated internally in the community; or power purchased from a local supplier outside the community, e.g., but not limited to, at wholesale rates). For example, the community management system provides for reduced power consumption during periods of peak power usage and allows increased power consumption during periods of lower power costs (“load shifting”). Such a system also provides for sale to and the input of excess power from both individual and community power generation apparatuses into an extra-community utility company or power grid. In certain aspects, a centralized community control system controls water supply and usage (both potable and grey water), e.g. for community drainage, community use, unit use, and community water features, e.g., but not limited to, during times of shortage, during repairs to a water system, or during a normal mode of operation; in particular, in times of drought, flood, emergency preparation, or emergency.

Both (or either) power and water are metered (home use and/or community use) and a central control system receives usage information and produces bills for each home and/or for the community.

Accordingly, the present invention includes features and advantages which are believed to enable it to improve community resource management and control technology. Characteristics and advantages of the present invention described above and additional features and benefits will be readily apparent to those skilled in the art upon consideration of the following detailed description of preferred embodiments and referring to the accompanying drawings.

Certain embodiments of this invention are not limited to any particular individual feature disclosed here, but include combinations of them distinguished from the prior art in their structures, functions, and/or results achieved. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

What follows are some of, but not all, the objects of this invention. In addition to the specific objects stated below for at least certain embodiments of the invention, there are other objects and purposes which will be readily apparent to one of skill in this art who has the benefit of this invention's teachings and disclosures. It is, therefore, an object of at least certain preferred embodiments of the present invention to provide:

New, useful, unique, efficient, nonobvious systems and methods for community-wide management of resources; and

Such systems and methods which provide for community-based supervision, monitoring, and/or control of power consumption, power allocation between individual and/or community resources, power production, and/or the sale of excess power;

Such systems and methods which provide for on-site and remote individual and/or centralized resource management, both individual resources and community resources; and

Such systems and methods that provide for, in certain aspects, management (both individual and community-wide) of resources, facilities, appliances, utilities, and functions including, but not limited to: apparatuses, systems, machines, and devices that consume or produce electrical power; irrigation systems; pool systems; water systems (treatment, use, re-use, and supply); lighting systems; security systems; a/c and heating systems (e.g. with thermostats, a/c units, heating units); water heaters; surveillance and alarm systems; sound systems; television systems; recreation facilities; and meeting facilities.

In certain aspects a community according to the present invention is a master planned community with residential and/or small business properties where new infrastructure (wiring, plumbing, controls) and apparatus standards are uniformly applied to each new structure. Such a community can include apartment complexes or townhomes, single family residence and/or multi-family residence as well as small commercial establishments, e.g. in shopping centers and/or local strip centers. In certain aspects, a municipality implements a system according to the present invention in staged arrangements and uniformly designs around large commercial properties. In certain aspects the units of a community according to the present invention include units of a business part.

In certain aspects a community according to the present invention includes an overseeing organizing influence, e.g., but not limited to, a homeowners association, developer, or real estate management company which establishes community standards and exerts authority in implementation of community controls.

The present invention recognizes and addresses the problems and needs in this area and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of certain preferred embodiments, given for the purpose of disclosure, when taken in conjunction with the accompanying drawings. The detail in these descriptions is not intended to thwart this patent's object to claim this invention no matter how others may later attempt to disguise it by variations in form, changes, or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly from a cursory inspection or review the nature and general area of the disclosure of this invention. The Abstract is neither intended to define the invention, which is done by the claims, nor is it intended to be limiting of the scope of the invention or of the claims in any way.

It will be understood that the various embodiments of the present invention may include one, some, or all of the disclosed, described, and/or enumerated improvements and/or technical advantages and/or elements in claims to this invention.

### BRIEF DESCRIPTION OF THE SEVERAL VIEWS OF THE DRAWING

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or legally equivalent embodiments.

FIG. 1 is a schematic view of a system according to the present invention.

FIG. 2 is a schematic view of a system according to the present invention.

FIG. 3 is a schematic view of a system according to the present invention.

FIG. 4 is a schematic view of a system according to the present invention.

Presently preferred embodiments of the invention are shown in the above-identified figures and described in detail below. It should be understood that the appended drawings and description herein are of preferred embodiments and are not intended to limit the invention or the appended claims. On the contrary, the intention is to cover all modifications, equivalents and alternatives falling within the spirit and scope of the invention as defined by the appended claims. In showing and describing the preferred embodiments, like or identical reference numerals are used to identify common or similar elements. The figures are not necessarily to scale and certain features and certain views of the figures may be shown exaggerated in scale or in schematic in the interest of clarity and conciseness.

As used herein and throughout all the various portions (and headings) of this patent, the terms “invention”, “present invention” and variations thereof mean one or more embodiments, and are not intended to mean the claimed invention of any particular appended claim(s) or all of the appended claims. Accordingly, the subject or topic of each such reference is not automatically or necessarily part of, or required by, any particular claim(s) merely because of such reference.

### DETAILED DESCRIPTION OF THE INVENTION

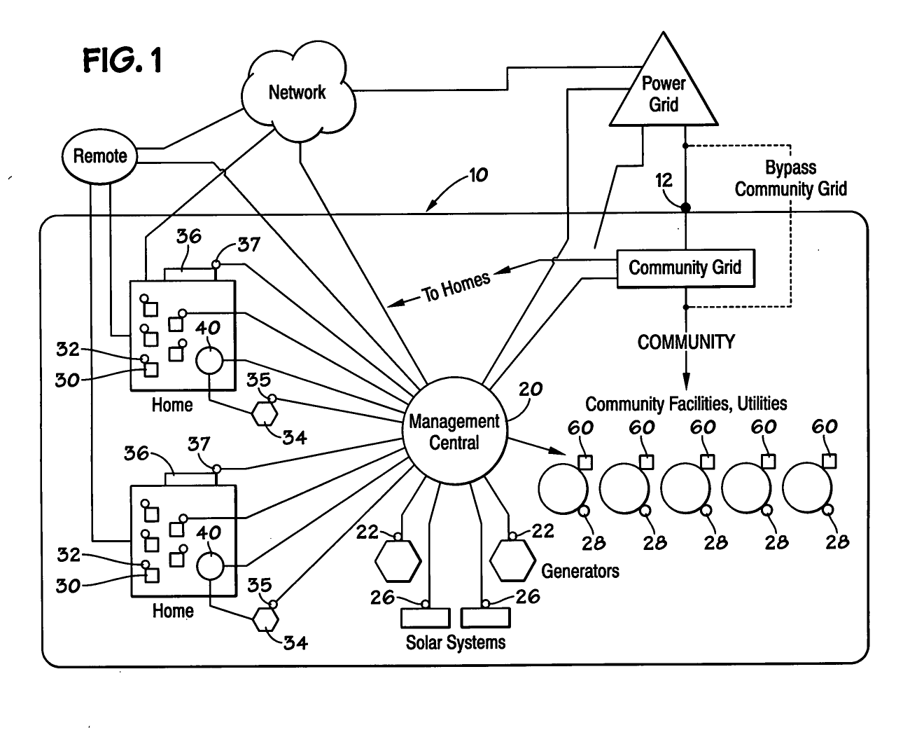

FIG. 1 illustrates a management system 10 according to the present invention which includes a central control system 20 (“MGMT. CENTRAL”) which monitors, controls, scheduling and/or communicates with a variety of facilities, apparatuses, controllers, sub-controllers, utilities, appliances, and devices. In one aspect the community central control system 20 monitors, controls, and communicates with sub-controllers 40 in each home and subcontrollers 60 of community resource facilities and utilities 28 (e.g. a community information center, recreation center, pro-shop, pool, water treatment system, water purification systems, street lights, lakes, reservoirs, and ponds). In certain aspects, the community central control system establishes a “mode of control” for an entire community (including unit, homes and/or community resource structures) and sets the stage for operational control of the community resources, such as power generation, potable water supply, grey water treatment and distribution systems, and additionally provides other services such as security, surveillance, environmental data and telemetry (measurement of value, quality, and/or the operational status of a particular community resource, e.g., data, energy, natural gas, electricity, and potable water supply).

In certain aspects energy and water conservation are the goals of a community management system 10 with alarm and security, power generation, lighting controls, telemetry and other services as natural come-along services developed out of the primary infrastructure. In certain aspects a system according to the present invention provides the ability to provide control from distant locations of both the unit or home and of the community, with surveillance capabilities. The interfaces and communication lines and links between the central control system 20 may be any suitable known wired and/or wireless methods, including, but not limited to, public switched telephone network; an IP (Internet protocol) network using landline or wireless communications; terrestrial or satellite mobile or fixed wireless systems; and point-to-point radio systems. In certain embodiments, described below IP over wired or wireless facilities are employed; but it is to be understood any interface and/or communication system may be used.

The community in certain aspects has a plurality of units or homes (“HOME”), each unit or home with a plurality of devices and apparatuses 30 which use electricity (e.g., but not limited to, lighting systems, alarm and surveillance systems, heating systems, cooling systems, pool systems, door/gate openers, appliances, electrical power-consuming devices and apparatuses and irrigation systems). Each apparatus 30 has a controller 32 (e.g., but not limited to a computer, or PLC) which is in communication with the control system 30 and with a home-based control system 40. In certain aspects, a standard wiring plan applies to each home (or unit) to facilitate the network of sensors and controllers. Each community asset can have a community device or apparatus like the devices or apparatuses 30.

Optionally a home can have its own dedicated electrical power generator 34 with a controller 35, the controller 35 is in communication with both the home control system 40 and directly or indirectly, with the central control system 20.

Optionally a home can have its own dedicated solar power generator 36 with a controller 37, the controller 37 is in communication with both the home control system 40 and, directly or indirectly (e.g. communicating to the home controller which in turn communicates to a central control), to the central control system 20.

In one aspect the central control system 20 and the home control system 40 use a network (“NETWORK”) to communicate with each other and/or to communicate with and/or control electricity-using devices and apparatuses. In one particular aspect, the network is the Internet. Each control system includes the necessary apparatuses, devices, computer(s), software, etc. for communication with the network and with each other.

Both the central control system 20 (“MGMT. CENTRAL”) and each home (or unit) control system 40 can be accessed from a remote location (“REMOTE”), via the homeowner for control of the home or via a management company regarding a community controller. This can be done via wire and/or wirelessly and it can be done via the public or private communications and data networks.

Optionally, the community has its own (one or more electrical power generators (“GENERATORS”) with controllers 22 which are in communication with the central control system 20. Optionally, the community has its own (one or more) solar power systems (“SOLAR SYSTEMS”) for generating electrical power. Each solar power system has its own controller 26 in communication with the central control system 20.

The community also includes a number of facilities and utilities 28 that consume electrical power (“COMMUNITY FACILITIES, UTILITIES”). The central control system is in communication with controllers 60 for each of these. In certain aspects, community facilities can include one, some (in any combination) or all of the following: apparatuses, systems, machines, and devices that consume or produce electrical power; irrigation systems; pool systems; water systems (treatment and supply); lighting systems; security systems; a/c and heating systems (e.g. with thermostats, a/c units, heating units); water heaters; surveillance and alarm systems; sound systems; television systems; recreation facilities; and meeting facilities; and ground water control and/or drainage systems.

Via its communication with the various systems and controllers, the central control system 20 can (directly or indirectly, via a home (unit) controller or via a community controller or sub-controller): monitor each electricity-consuming item (e.g. but not limited to, each major electricity consuming item) and/or total usage at a specific location; turn an item on or off, adjust an item's power consumption; and/or provide an alarm related to an item's performance or status. By monitoring power consumption for the community, and power production by home-based or community generators (and solar power system((s)) if present), the central control system can provide for the input (and sale) of electrical power into a local power company or local power grid (“POWER GRID”) or into the community system or a community power grid (“COMMUNITY GRID”), e.g. the wires, pipes, etc. that connect each unit or home or business into a common grid for supply and demand at each home, unit, business and/or community facility. A community grid is separated from commercial power/water/gas supply transmission and distribution at a point-of-interconnection (“POI”) e.g. a POI 12 is a point of demarcation beyond which the community can no longer exercise “community mode” controls. In one aspect, all community power/gas/potable and grey water is measured at the POI via a Net Usage Meter to determine how much and when resources are being generated or consumed by the community. The community and/or the individual home owner receives any monetary reimbursement from a power-providing entity that receives the excess power from the community. In all operations, the community grid can be bypassed in favor of the local power grid.

The central control system 20 also monitors the individual and community-wide power usage and turns power-consuming items off and/or adjusts power-consuming items to use less power as desired, e.g., by establishing a power conservation mode of operation for individual controllers 32, 35, 37, 40, and 60. For example, in one particular circumstance, during a period of high power demand (intra- or extra-community) and/or during a period during which power is relatively expensive, the central control system 20 establishes a mode of operation for the other controllers that either turns off, cycles, or adjusts power-consuming items to reduce individual home and/or community-wide peak power consumption thus providing a dynamic demand side management capability. In another aspect, the central control system 20 implements a free-running mode for the other controllers in which the controllers establish energy management and conservation controls based on software configured by the user or by the community. This mode of operation is deemed “normal operation mode”, or is implemented if the central controller 20 fails or supervisory signals from the central controller system fail to reach the controllers. In this mode of operation, an individual home (or unit) owner may opt out of community level participation, in one aspect resulting in a premium price for power.

In one particular aspect the community generators provide sufficient power for a predetermined period of time to power a predetermined set or number of individual home and/or community power consuming items (e.g. during a period of extended power outage from an external power supplier): e.g., but not limited to, sufficient electricity for lights, ovens, medical devices, and fans in each home and limited community emergency facilities for invalids and/or injured persons until they are moved from the community.

In another aspect the central control system 20 implements community wide controls. For example, the system 20 starts the community generators, shut off community water fountains, irrigation systems, starts flood control pumps, shuts off HVAC units in community facilities and centers and information centers, and/or turns on surveillance cameras and/or initiates gate controls and/or motion sensors while monitoring a community water supply and/or does these things for individual units of the community. In one aspect only fundamental services, e.g. home lighting and critical community resources are kept in service during an event period. In certain aspects, both homes and community facilities include energy usage meters and meters for both potable water and grey water supply. In one aspect these meters operate in real time.

In another aspect, the central control system is used for community emergency resource management; in one aspect through a third party infrastructure provider, e.g. a company hired to manage and maintain community resources for the purpose of day-to-day operation conservation periods, and/or emergencies.

Via remote access (“REMOTE”) an individual home and the power-consuming items in it can be monitored, adjusted, supervised, and controlled. As is the case for the central control system 20, this can be done for each home in real time and, optionally, with access to the historical data for each item and/or facility. For every function and operation of any control system or computerized apparatus in any system according to the present invention, historical data relating thereto is recorded, stored, and available on demand both at the community level via a community control system and/or at the individual home level. Remote access can be done with a PDA or computer in communication with the home control system 40; in one aspect, via the network (e.g. the Internet) either with a Remote-Network-Home Control System connection or with a Remote-Network-Central Control System-Home Control System connection, wired or wireless.

Power generation at an individual home (or unit) can occur outside the control of a home controller 40 and the central control system 20. Solar systems can perform in the presence of adequate sunlight and generators at the home can operate if the primary power source to the home fails. Home controllers 40 can be aware of the state of home energy sources without controlling their operation.

In one particular aspect of each and every system and method according to the present invention, an individual home or unit) may (at any time, in any situation) opt out of the community control program and override any attempt by the central control system 20 to control anything related to the individual home, e.g., when the system 20 is in a free-running mode or in a demand side management mode. “Free-running” mode is a default mode of operation which may occur when communication is lost between the Central Control 20 and the Home Control 40 where Home Control works independently from Central Control or in the event that no constraints of use are enabled in the community or for a particular home or unit. In demand side management mode the Central Control is optimizing resource efficiency for the community as a whole and not for a particular home or unit.

In another particular aspect, any individual who enters the individuals home (or unit) into the community program is unable to opt out and submits to community control by the central control system 20 when, in its sole discretion, the central control system 20 deems central control appropriate (except, in one aspect, in a free-running mode).

In one aspect of operation, the home controllers 40 and the user interfaces 41 may include some, all or none of the home sub-controllers 32, 35, 37 depending upon size and sophistication of the community. Similarly, central control system 20 may not require a community resource sub-controller depending on size and configuration as well as level of sophistication. In one particular aspect, a home controller according to the present invention includes in a basic box, all alarm and security controls for the home, energy management controls, lighting controls, irrigation controls and the software to support a touch screen monitor for consumer input, output as well as an option for full PC support for the consumer interface.

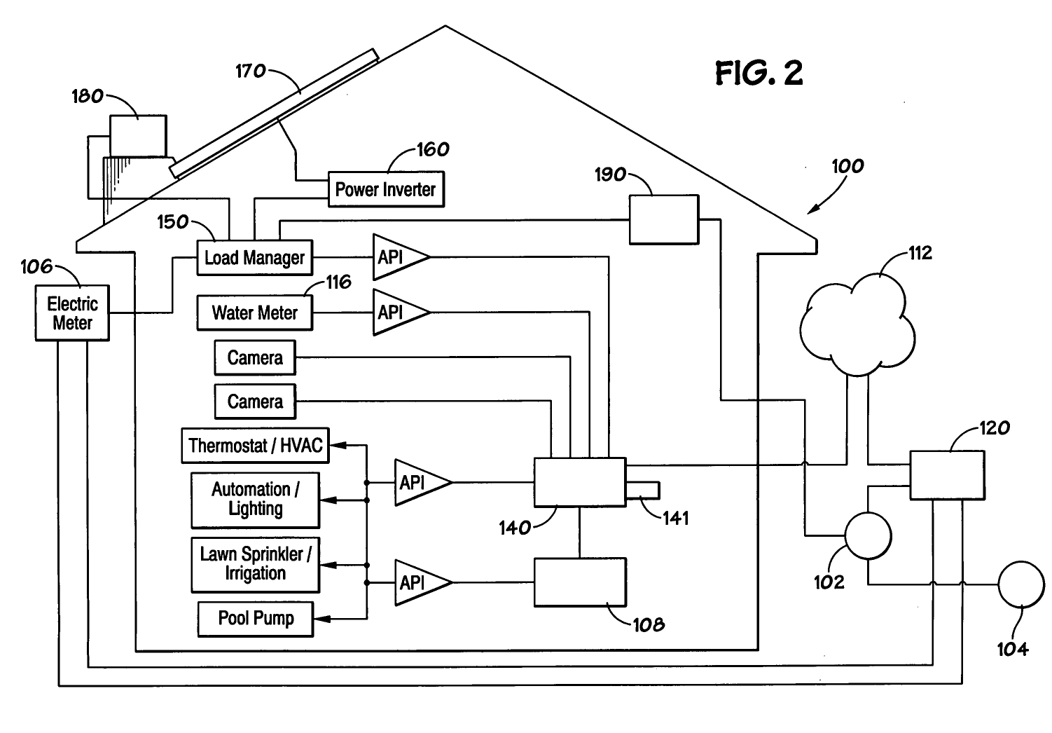

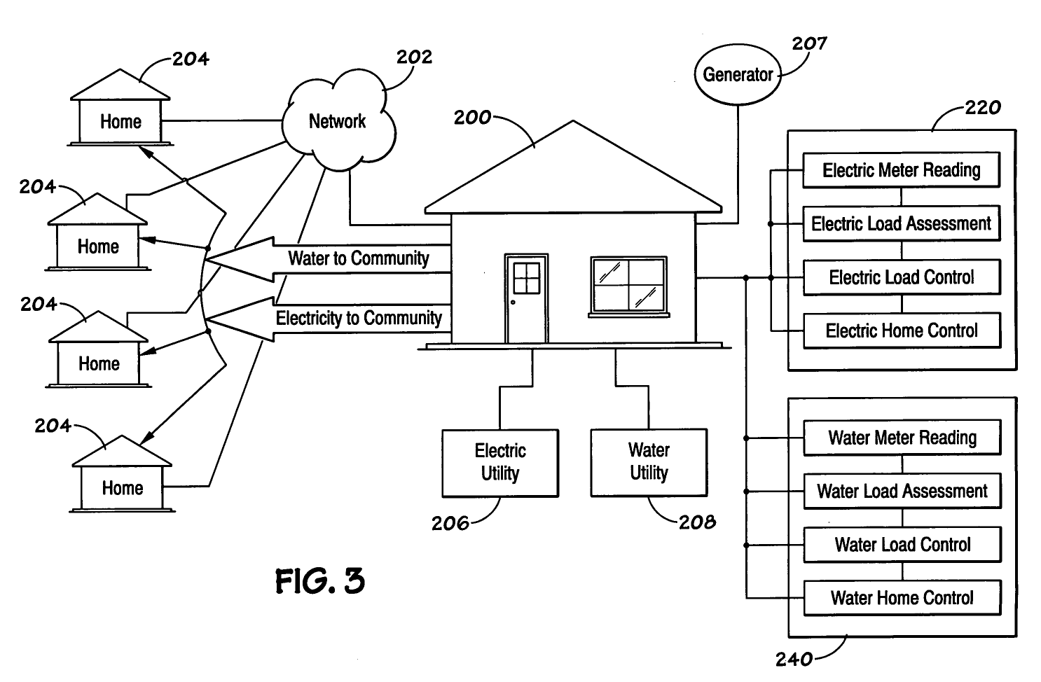

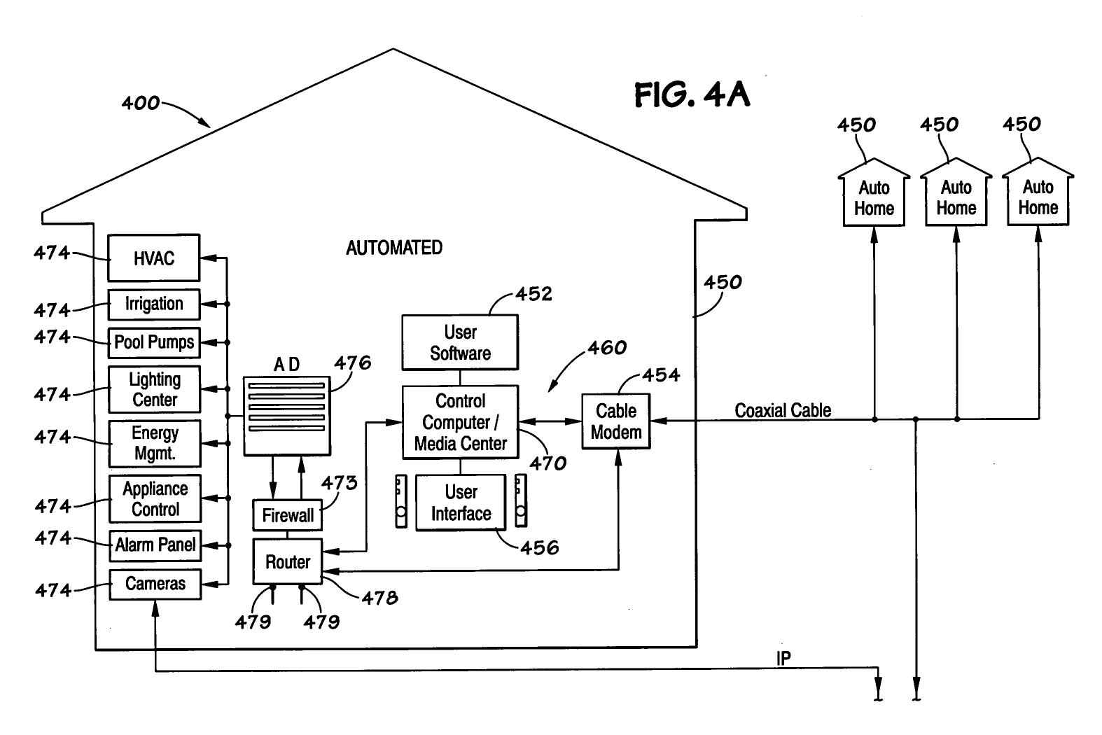

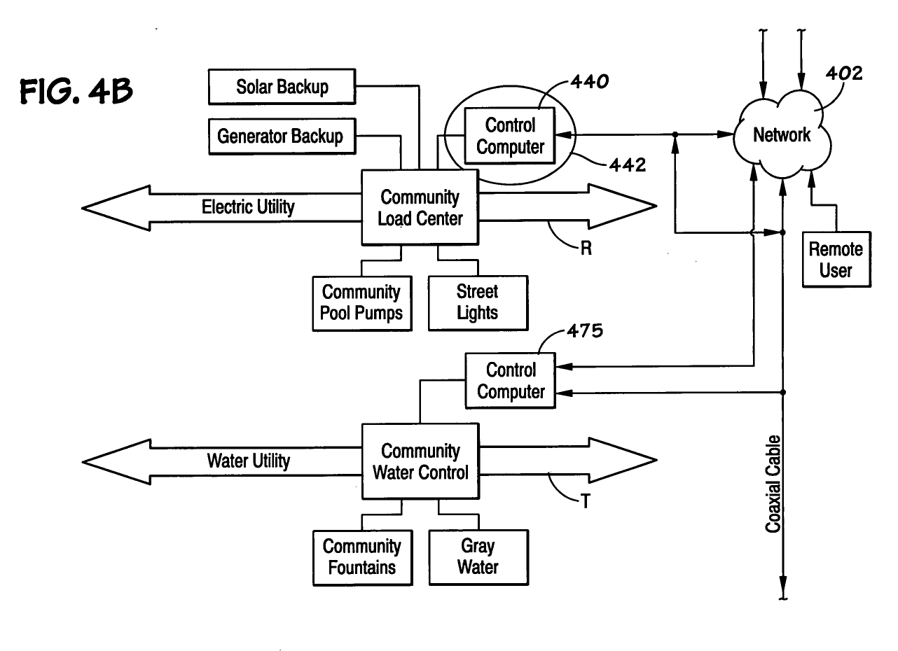

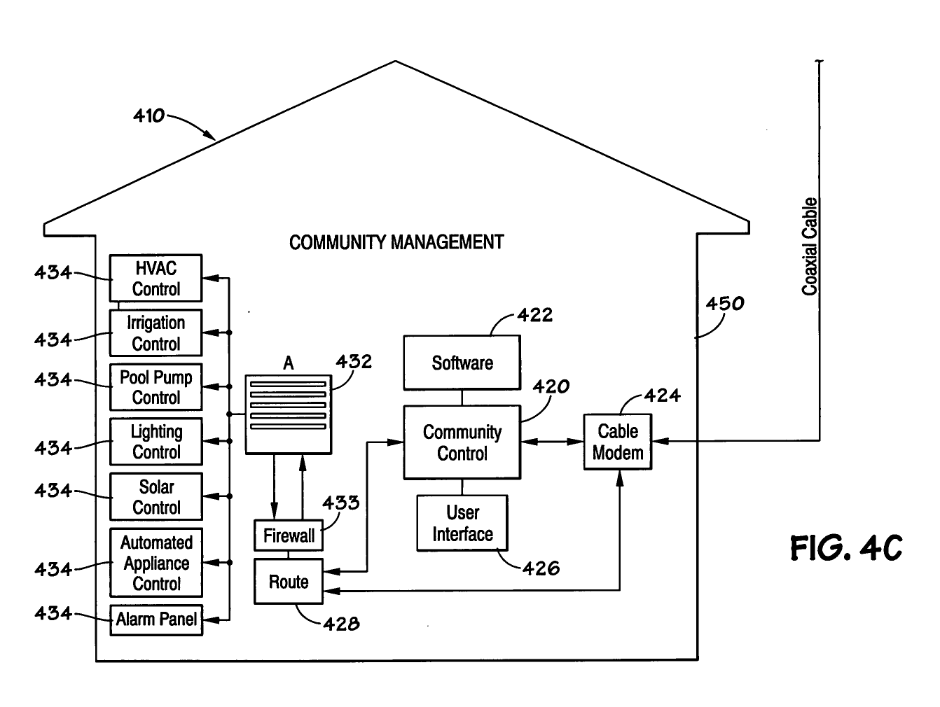

FIG. 2 illustrates schematically a home 100 according to the present invention useful in systems and methods according to the present invention. It is to be understood that one, some (in any combination) or all of the aspects shown in FIG. 3 may be in the homes of the systems and methods of FIG. 1 and FIG. 4.

The home 100 has a control system 140 (e.g. like the controllers 40, FIG. 1) that communicates with a central control system 120 (like the central control system 20, FIG. 1, or the central control system 220, FIG. 4, or like any central control system according to the present invention), e.g. via a network 112 (e.g. a private network or the Internet, wired or wireless) and a consumer interface 141 that in one aspect is a simple monitor with input and output (touch screen or keyboard) and in another aspect is a PC-based system with monitor and advanced digital home capabilities (e.g. a PC system with software packages used in conjunction with input/output ports to deliver information to a consumer regarding relative status of the home and/or of the community. These monitored devices can provide everything from alarm status and surveillance camera images to water usage, energy usage, outside temperature and forecasts). In one aspect various controllers and devices of the home are connected directly to the home controller 140 (wired or wireless using any protocol) and their controllers (150, 116, 108, etc) are physically contained in the home controller 140. In another aspect various controllers and devices are not included in the home controller 140 and appear in separate locations throughout the structure. The system 140 is in communication (wired and/or wireless; as may be any communication between any two or more entities, items and/or apparatuses in any system herein) with a variety of items, apparatuses, devices, and appliances as listed in FIG. 2. Via the Control System 140-Network-Control System 120 linking, a central entity can also monitor and control the various items, etc. in the home 100.

The home 100 includes an energy management system 150 for managing power usage, input and output. The system 150 is in communication (wired or wireless) with the control system 140 and with a power inverter 160, a solar power collector system 170, and/or an on-site electrical power generator 180 (either system 170, 180 may, optionally, be deleted) and an external source of power, e.g. from the Power Grid or the Community Grid.

The energy management controller 150 monitors usage within the home and manages the sources and uses of power in accordance with software algorithms contained within the controller 150 as well as communitywide modes of operation established by central control system 20 and the home controller 140. Software algorithms in software in the energy management controller 150 are established by the home owner (free-running or demand side management mode of the central control system 20) or by central control system 20 in other modes of operation. The energy management controller is usually connected to major appliances in the home at the load center 190 (e.g., HVAC controls, pool pump controls, water heater controls) but is not restricted to these devices). Additionally, the energy management system 150 is connected to various monitoring devices such as the electric meter and thermostats. The energy management system 150 monitors power generated by the system 170 and/or the system 180 and provides it to a distribution system 190 (commonly referred to as the load center). In one aspect the power distribution system 190 is a wiring cabinet where all electrical (e.g. 115/220 VAC) appliances are interconnected to the supply side of power to the home utilizing circuit breakers. The distribution system 190 provides electric power to the various power-consuming items in the home and is also connected to a community grid 102 which a community-wide system (which may be part of the community system of any embodiment disclosed herein and specifically of the systems of FIG. 1 and of FIG. 4). The system 102 is monitored and controlled by the central control system 120. The system 102 is, optionally, selectively connectible to a power supply operation within the community or power grid 104 (like the “POWER GRID,” FIG. 1) (e.g. an external source of power to the community, e.g. an incumbent local power company). In certain aspects, all electricity passes through the system 190 onsite and is monitored by the energy management controller 140 which in turn communicates with home controllers and stores information, such as which source is providing the electricity and how much electricity is being generated and consumed by specific devices. In one aspect, via IP (Internet Protocols) protocols, the system includes automated meter reading, billing, load management, power distribution and generation at the community level.

The system 190 connected to each electricity-using device via circuits and is the point at which the home's electricity supply and load meet.

A meter 106 monitors electric current usage in the home 100 in real time, including power produced by the systems 170 and/or 180 and power consumed by the devices and appliances in the home 100. Signals indicative of this flow and usage monitored by the system 150 in the home are sent to the central control system 120, directly and/or via the controller 140. In one aspect the energy management system provides usage and predicated billing expense to a user via a home controller/user interface 141. In another aspect the energy management system 150 provides usage date to the home controller 140 which communicates such usage data to management central 120 for use in generating consumer bills, maintaining historical load management for the community and predicting future power demand for the community.

The consumer interface 141 can, in a particular aspect include radio, television, CD, DVD, movie playback, and Internet entertainment access as well as a major interface for all home automation activities, e.g., energy management, water conservation and re-use (e.g. grey water systems), and home and security alarm and surveillance. The system 141 may include one or more computers within or adjacent the home, e.g. but not limited to, laptop(s) and/or desktop(s) computers which are usable to act as and/or operate the control system 140. In certain particular aspects, this consumer interface is a PC (personal computer) (as may be true of any control system for any home according to the present invention) includes: an operating system (e.g., but not limited to a MAC system or Windows XP Media Center Operating Systems) with software to support home automation and home entertainment. The home entertainment software can include support and control of television viewing. From a remote control, a person can control a channel viewed, the volume and also recording of television programming and be able to select a radio station and volume or play music from CDs or MP3s.

In certain aspects, the home automation software includes a form of intelligence for learning the routines of a homeowner and requirements for optimizing the efficiency of the electrical appliances within the home. These capabilities include sampling atmospheric environment within the home to determine an appropriate time to return a thermostat setting to a predetermined comfort level to maximize energy efficiency while providing the comfort desired by the homeowner. The timing for the thermostat adjustment will be affected by the temperature inside the home, outside the home and the ability of the air conditioning system to cool the environment within the home.

In certain aspects the control system 140, in conjunction with the system 141 (or a basic monitor) also provides for the automation and remote control of functions both onsite and from geographically remote locations via a network; e.g. for remote viewing and recording television content and surveillance cameras and remote and local control of lighting and thermostats and other home controls supervised by the system 140.

In certain aspects the remote access functions mentioned are implemented using existing Internet protocol communications devices, but may use wired or wireless telecommunications, data, or ISP oriented communications technologies. Certain components may have a telephone interface to allow control using standard POTS telephone service or may use wireless, telephone or data communications according to specifications of the devices purchased by a consumer. Using these protocols enables an end-user to remotely access, monitor and control items, activities, or areas within a home.

FIG. 3 illustrates a centralized community control system 200 according to the present invention which may be used with any system, with any method, and with any community according to the present invention (including, but not limited to, those of FIGS. 1, 2, and 4). Via a network 202, the control system 200 is in communication with units 204 (any business and/or home disclosed herein) of the community (and, in certain aspects, with item(s) and thing(s) at each home). The control system 200 monitors power provided by a third party electric utility 206, (e.g. an incumbent power company) and power provided from within the community via renewable sources and generators 207 and a third party water utility 208 which provides water to the community (both grey and potable water).

The control system 200 includes an electric power subsystem 220 and a water subsystem 240 for the community resources which may include both potable and grey water (purified and sanitized discharge from the home). The control system 200 may also connect to auxiliary devices such as satellite weather data systems in order to determine actual rainfall amounts or predictions prior to enabling or disabling home and community irrigation system. The electric subsystem 220 provides signals to the control system 200 regarding the communities resources (e.g. recreations center, information center, pumps for pools-golf course irrigation and community flood control and drainage) generators and etc.); electrical meter readings and load (usage, real-time, historical). The electric subsystem 220 also interprets the community mode of operation from community controller 200 to the devices controlled throughout the community. The basis for the community mode of operation is established by the control system 200 based on current community usage, community generated power, and external factors such as weather conditions, emergency events and the conservation preferences of the community. In one aspect the control system 200 and the power subsystem 220 may be included in one device. The system 200 can provide load assessment, a determination of total power load of the community including power generated at each home and at community locations such as information centers, recreation centers and established community generators and externally supplied power from an incumbent local power company. Total usage is then balanced against the desires of the community (conservation needs and cost) to determine a mode of operation the controller 200 will establish for the community. The mode of operation for the community may be overridden by the controller 200, e.g. if an emergency condition is known to the controller 200, when external power is lost to the community grid or when any other condition exists that may impact the decision tree of controller 200, including manual intervention.

The system 200 can also provide load control, i.e. the system 200 can establish a mode of operation for the entire community that results in the home controllers and community controllers delaying certain devices from operating (e.g. home HVAC systems or community fountains, street lighting and irrigation system pumps, or pool pumps) or can dynamically rotate permission to operate or totally shut down such resources in an effort to balance power supplied internally to the community versus externally provided power to the community to meet cost, conservation or emergency circumstances.

The water subsystem 240 provides signals to the control system 200 regarding each home's water meter readings and load (usage, real-time, historical) for potable water and grey water systems. The subsystems responsibilities are to know the state and availability of potable water supplies within the community, balance usage of both water supplies against demand and report usage data to the control system 200 useful in billing, forecasting and load management. The subsystem 240 can also interpret a community mode of operation to devices under its control.

FIG. 4 illustrates a system 400 according to the present invention which has a centralized community control system 410 which communicates with a plurality of homes 450 (one shown in some detail; any number possible) via a network 402. The homes 450 may be like any home disclosed herein and any home in any system and method according to the present invention may be like the home 450 and/or have one, some (in any combination) or all the aspects and features of a home 450. The network may be any network (private or public, wired or wireless) disclosed herein, e.g., but not limited to, the Internet. Elements of the system 400 are in communication with each other via wires or wireless systems or satellite facilities (wired or wireless) using standard telecommunications, data, or ISP protocols.

The community control system 410 has computer apparatus 420 (e.g. a server) which includes (as does any control system according to the present invention and any control system in FIGS. 1, 2, 3) any suitable computerized apparatus, device, computer or computers with programmable media programmed with appropriate software 422 to accomplish each function of the community control system 410. A cable modem 424 provides an interface between the network 402 and the community control system's computer apparatus 420.

Any suitable known interface 426 may be used to provide a user or users access to the computer apparatus 420, e.g., but not limited to touch screen system(s), laptop computer(s) and/or desktop computer(s) with associated monitor(s) and mouse.

The computer apparatus 420 controls and communicates with various items 434 via, in one aspect a Local Area Network accomplished by assigning each system's controller 432 an IP address and connecting via Ethernet/wirelessly to a ROUTER 428 which is, optionally, protected by a dedicated firewall apparatus 433 which may also be an integrated part of the ROUTER 428. The items 434 may include one, some, (in any combination), or all of the following: HVAC Systems; Irrigation Systems; Pool pump Systems; Lighting Systems; Solar Systems; Automated Appliance Systems; Alarm Panel. Each of these “controls” includes appropriate connections between the community control system 410 and community resources (Community HVAC, irrigation, etc.) and/or individual home resources (home surveillance system, home solar collector system, home A/C, etc.). In certain particular aspects such “controls” include the ability to turn attached systems 434 or parts thereof on/off, adjust levels, control physical state e.g. close curtains/open dampers. These controls may also receive and carry out pre-programmed instructions via software on the Community control Server 420 or and/or the home controller 470.

Via appropriate connections, e.g., but not limited to coaxial cable and optical fiber, the community control system 410 monitors, communicates with and controls community power usage and production and community water usage.

Regarding electric power control, a community electricity control computer 440 at a community POI 442 communicates directly with the computer apparatus 420 and/or via the network 402. The community electricity control computer 440 will monitor devices to measure community-wide control usage at the POI, commonly referred to as a net usage meter (NUM) and to communicate this information with the community control server 420 via a network 402. As desired above regarding other embodiments and regarding those of FIGS. 1-3, the community control system 410 monitors, supervises, controls, and allocates electrical power usage, flow, and production for the community, both for each home and for the community resources.

Regarding water control, a water control computer 475 communicates directly with the computer apparatus 420 and/or via the network 402. The community water control apparatus includes, in one aspect, a meter to determine usage/flow/quality of water being used in the community at the POI, and, in certain aspects, is capable of reading these various measurements and the ability to send the status back to the community control server 420. As described above regarding other embodiments and regarding those of FIGS. 1-3, the community control system 410 monitors, supervises, controls, and allocates water usage and flow for the community, both for each home and for the community resources.

The arrow R represents the community's electrical grid. T represents the community's water (potable and grey-water) grid.

The homes 450 have a control system 460 in one configuration consisting of a home controller 470 connected via a cable modem 454 and coaxial cable to the computer apparatus 420 of the community control system and via coaxial cable and a router 478 to the computer apparatus 420 of the community control system via the network 402 (or connected to the computer apparatus 420 via the network 402 with direct cable modem 454).

The control system 460 has computer apparatus 470 with any suitable device, computer, computerized apparatus, or computers with programmable media programmed with appropriate software 452 to accomplish each function of the control system 460.

Any suitable known user interface 456 is used.

The computer apparatus 470 communicates with and controls various items 474 via a router 478 which assigns each device's or system's controller 476 an IP address to mark each controller's position on and essentially creating a Local Area Network. In this way it routes information to each device controller 476 from the home controller 470 and the community controller 420. The router can also receive signals form each device's controller 476 and send them to the home controller 470 and/or to the community controller 420 via the network 402. The items 474 may include one, some (in any combination or all of: HVAC system; irrigation system; pool pump system; lighting; appliance(s); alarm system; and/or surveillance camera(s).

All network interfaces in any system according to the present invention support communication by established Internet protocol standards including, but not limited to TCP, IP, UDP, SPX, SIP, DHCP to accomplish interconnection of all items connected to the network and a control system or control systems. In certain aspects control system interfaces translate commands received via Internet protocol to an appropriate protocol to facilitate control of a specified device attached to the network. Such devices can include, e.g., thermostat, lighting, water heater, pool pump, irrigation system, gate/door opener, power generator, stereo, television, surveillance equipment and alarm system. If some of the control protocols are proprietary, multiple controllers may be required to accomplish a desired interconnectivity and control. Home automation and lighting controls supported include, e.g., X-10, Lutron, Cestron, Z-wave, UPB, and other protocols. The same network that interconnects the devices can allow for communication between devices so that operation of one device can affect another device on the network. One example of such operation would be adjustment of a thermostat to a higher setting and turning off all lights by a command received by a thermostat controller and a lighting controller as a signal is transmitted by an alarm system being armed in the away mode.

A wireless access point will allow for access by remote devices on premises (e.g., at home, a club, etc.) such as a PDA, laptop or other suitable remote control device to extend the utility of the network device control on premises. In certain aspects a Wireless Access Point 479 (see “REMOTE” indications on the drawings, which allows for remote access through a wireless network and additionally allows for device controllers 476, the home controller 470 and the community control 420 to all communicate wirelessly) will utilize any suitable wireless protocol, including, but not limited to, existing 802.11b or 802.11g wireless protocols to accomplish interconnectivity with a central processor and a local network.

In certain aspects systems according to the present invention include home entertainment features. A control system providing such features according to the present invention includes hardware and software to facilitate control, distribution and storage of entertainment media such as television programming and recording, audio programming and recording and surveillance equipment. Hardware may include a radio receiver, DVD player/recorder video capture card and/or multiple television tuners. Software may include Windows XP Media Center and/or other programs to enable recording of video surveillance and other functions as required by the implementation.

In certain aspects, via IP (Internet Protocol) interconnectivity, a community central control system according to the present invention (which may be any discussed above) gathers usage information (e.g. for electric power and/or water) and performs billing functions at the community level. The control server and interface user includes control functions which can be activated at the community level in brown-out conditions and periods of peak usage, as well as other control functions. Through preprogrammed settings the community server sends broadcast messages via the community network. In response to a broadcast message, equipment is adjusted through the control devices 440, 450, 470 settings for operation at reduced consumption levels, thereby providing the management tools to accomplish load reduction as needed.

In certain aspects, when conservation of energy is necessary, the system at the community control level broadcasts, via the local network to all affected devices within the community, a signal to adjust these devices for maximum efficiency or restrict their operation to affect or eliminate the load as needed. This capability is applied, in certain aspects, to water systems in the same manner. For example, during periods of drought when restrictions on lawn watering are applied, the central community control system broadcasts messages to restrict the operation of automated home and/or community lawn sprinkler systems. In certain aspects, this system of control is versatile in a manner such that operation of lawn sprinklers is restricted to operation on certain days or disallowed completely.

For any central and/or community control system in any embodiment of the present invention, any entity or person(s) can be designated as controlling such a central and/or community control system including, but not limited to, a home owner's association, a subdivision or area developer, or some other designated entity (or some combination of entities).

The present invention, therefore, provides in at least some embodiments, a community system for management of a plurality of community assets of a community and of unit assets of each of a plurality of individual units of a community, the system having: a central control system in communication with each community asset for managing each community asset; each individual unit of the plurality of units of the community having a unit manager in communication with each unit asset for managing each unit asset; the central control system in communication with each unit manager for selective management of each unit asset by the central control system; and a network system providing for communications between the central control system and each unit manager and providing for communications between the central control system and each community asset. Such a system may have one or some, in any possible combination, of the following: wherein the community has community resources systems and the central control system manages the community resource systems; wherein the community resource systems include any or all of power generation system, water supply system, natural gas system, water treatment system, natural gas system, and water purification system; wherein the community assets include any of community lighting system, community facility, community pool, community recreation center, community security system, community alarm system, community heating system, community power-consuming item, and community cooling system; wherein the unit assets include any of unit lighting system, unit security system, unit alarm system, unit pool, unit cooling system, unit heating system, and unit power-consuming system; community remote apparatus for remote control of the central control system; for each unit manager, a unit remote apparatus for remote control of unit assets; wherein each unit asset has an individual unit controller and each unit manager is in communication with that unit's individual unit controllers for managing each unit asset; wherein managing of each community asset includes monitoring, controlling, adjusting and scheduling each community asset; wherein the plurality of community assets includes a community power (electricity and/or natural gas) generating system; wherein the community power generating system provides power for a predetermined time period for any of a community asset or a unit asset during a period of power outage; wherein at least one of the units has a unit power generation system; wherein at least one of the units is all of the units; wherein the network system is any of a public switched telephone network, an Internet protocol network, a wireless network, and a point-to-point radio system; wherein the central control system monitors community power consumption; wherein the central control system monitors unit asset power consumption; wherein the community has a community power generation system and the central control system manages the provision of power generated by the community power generation system to an extra-community third party; wherein at least one unit has a unit power generation system and the central control system manages the provision of power generated by the community power generation system to an extra-community third party; wherein the community has at least one community-wide power consuming item, each unit has at least one unit power-consuming item, the central control system monitors power usage by the at least one community-wide power-consuming items and power usage by the at least one unit power-consuming item, and the central control system manages power consumption by the at least one community-wide power consuming item and the at least one unit power-consuming item; wherein managing of power consumption by the central control system includes any of establishing a power conservation mode of operation, turning off a power-consuming item, adjusting supplied power, and cycling power supply to a power-consuming item; wherein any owner of a unit may decline control by the central control system of said unit's power-consumption; the community resources including water resources, water meter apparatus for metering community water usage and for sending water meter signals indicative of said community water usage to the central control system, and the central control system managing the water resources based on the water meter signals; wherein the community resources include resources for which individual units are invoiced, the community system including the central control system providing invoices to each individual unit for resources consumed by each individual unit; wherein the community resources include resources for which individual units are invoiced, the community system further including the central control system providing a prediction to each individual unit of resources predicted to be consumed for each individual unit for a time period; wherein the community system has a consumer interface at each individual unit able to communicate with the central control system and with a unit manager at a corresponding individual unit; wherein the consumer interface is a computer; wherein each individual unit is any of a home and a business; wherein the central control system is able to preempt control of all unit assets and to exclude all unit managers from control of unit assets; and/or wherein the community resources include electrical power resources, the community system has electrical power meter apparatus for metering community electrical power usage and for sending electrical power meter signals indicative of said electrical power usage to the central control system, the central control system managing the electrical power based on the electrical power meter signals; and/or wherein the community resources include natural gas resources, the community system has meter apparatus for metering community natural gas usage and for sending meter signals indicative of said usage to the central control system, the central control system managing the natural gas resources based on the meter signals.

The present invention, therefore, provides in at least some embodiments, a system for management of a plurality of community assets of a community and of unit assets of each of a plurality of individual units of a community, the system has: a central control system in communication with each community asset for managing each community asset; each individual unit of the plurality of units of the community having a unit manager in communication with each unit asset for managing each unit asset; the central control system in communication with each unit manager for selective management of each unit asset by the central control system; a network system providing for communications between the central control system and each unit manager and providing for communications between the central control system and each community asset; wherein the community has community resources systems; the central control system manages the community resource systems; wherein the community resource systems include any of power generation system, natural gas system, water supply system, water treatment system, and water purification system; wherein the community assets include any of community lighting system, community facility, community pool, community recreation center, community security system, community alarm system, community heating system, community electrical power-consuming item, and community cooling system; wherein the unit assets include any of unit lighting system, unit security system, unit alarm system, unit pool, unit cooling system, unit heating system, and unit electrical power-consuming system; wherein managing of each community asset includes monitoring, controlling, adjusting and scheduling each community asset; wherein the network system is any of a public switched telephone network, an Internet protocol network, a wireless network, and a point-to-point radio system; the community resources including water resources; water meter apparatus for metering community water usage and for sending water meter signals indicative of said community water usage to the central control system; the central control system managing the water resources based on the water meter signals; wherein the community resources include electrical power resources, the community system further including electrical power meter apparatus for metering community electrical power usage and for sending electrical power meter signals indicative of said electrical power usage to the central control system; and the central control system managing the electrical power based on the electrical power meter signals.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to the step literally and/or to all equivalent elements or steps. The following claims are intended to cover the invention as broadly as legally possible in whatever form it may be utilized. The invention claimed herein is new and novel in accordance with 35 U.S.C. § 102 and satisfies the conditions for patentability in § 102. The invention claimed herein is not obvious in accordance with 35 U.S.C. § 103 and satisfies the conditions for patentability in § 103. This specification and the claims that follow are in accordance with all of the requirements of 35 U.S.C. § 112. The inventors may rely on the Doctrine of Equivalents to determine and assess the scope of their invention and of the claims that follow as they may pertain to apparatus not materially departing from, but outside of, the literal scope of the invention as set forth in the following claims. All patents and applications identified herein are incorporated fully herein for all purposes.

What is claimed is:

1. A community system for management of a plurality of community assets of a community and of unit assets of each of a plurality of individual units of a community, the system comprising
a central control system in communication with each community asset for managing each community asset,
each individual unit of the plurality of units of the community having a unit manager in communication with each unit asset for managing each unit asset,
the central control system in communication with each unit manager for selective management of each unit asset by the central control system, and
a network system providing for communications between the central control system and each unit manager and providing for communications between the central control system and each community asset.

2. The community system of claim 1 wherein the community has community resources systems and
the central control system manages the community resource systems.

3. The community system of claim 1 wherein the community resource systems include any of power generation system, water supply system, natural gas system, water treatment system, and water purification system.

4. The community system of claim 1 wherein the community assets include any of community lighting system, community facility, community pool, community recreation center, community security system, community alarm system, community heating system, community power-consuming item, and community cooling system.

5. The community system of claim 1 wherein the unit assets include any of unit lighting system, unit security system, unit alarm system, unit pool, unit cooling system, unit heating system, and unit power-consuming system.

6. The community system of claim 1 further comprising
community remote apparatus for remote control of the central control system.

7. The community system of claim 1 further comprising
for each unit manager, a unit remote apparatus for remote control of unit assets.

8. The community system of claim 1 wherein each unit asset has an individual unit controller and each unit manager is in communication with that unit's individual unit controllers for managing each unit asset.

9. The community system of claim 1 wherein managing of each community asset includes monitoring, controlling, adjusting and scheduling each community asset.

10. The community system of claim 1 wherein the plurality of community assets includes a community power generating system.

11. The community system of claim 10 wherein the community power generating system provides power for a predetermined time period for any of a community asset or a unit asset during a period of power outage.

12. The community system of claim 1 wherein at least one of the units has a unit power generation system.

13. The community system of claim 1 wherein at least one of the units is all of the units.

14. The community system of claim 1 wherein the network system is any of a public switched telephone network, an Internet protocol network, a wireless network, and a point-to-point radio system.

15. The community system of claim 1 wherein the central control system monitors community power consumption.

16. The community system of claim 15 wherein the central control system monitors unit asset power consumption.

17. The community system of claim 1 wherein the community has a community power generation system and the central control system manages the provision of power generated by the community power generation system to an extra-community third party.

18. The community system of claim 1 wherein at least one unit has a unit power generation system and the central control system manages the provision of power generated by the community power generation system to an extra-community third party.

19. The community system of claim 1 wherein
the community has at least one community-wide power consuming item,
each unit has at least one unit power-consuming item,
the central control system monitors power usage by the at least one community-wide power-consuming items and power usage by the at least one unit power-consuming item, and
the central control system manages power consumption by the at least one community-wide power consuming item and the at least one unit power-consuming item.

20. The community system of claim 19 wherein managing of power consumption by the central control system includes any of establishing a power conservation mode of operation, turning off a power-consuming item, adjusting supplied power, and cycling power supply to a power-consuming item.

21. The community system of claim 1 wherein any owner of a unit may decline control by the central control system of said unit's power-consumption.

22. The community system of claim 2 further comprising
the community resources including water resources,
water meter apparatus for metering community water usage and for sending water meter signals indicative of said community water usage to the central control system, and
the central control system managing the water resources based on the water meter signals.

23. The community system of claim 2 wherein the community resources include resources for which individual units are invoiced, the community system further comprising
the central control system providing invoices to each individual unit for resources consumed by each individual unit.

24. The community system of claim 2 wherein the community resources include resources for which individual units are invoiced, the community system further comprising
the central control system providing a prediction to each individual unit of resources predicted to be consumed for each individual unit for a time period.

25. The community system of claim 1
wherein the community system further comprises
a consumer interface at each individual unit able to communicate with the central control system and with a unit manager at a corresponding individual unit.

26. The community system of claim 25 wherein the consumer interface is a computer.

27. The community system of claim 1 wherein each individual unit is any of a home and a business.

28. The community system of claim 1 wherein the central control system is able to preempt control of all unit assets and to exclude all unit managers from control of unit assets.

29. The community system of claim 2 wherein the community resources include electrical power resources, the community system further comprising
electrical power meter apparatus for metering community electrical power usage and for sending electrical power meter signals indicative of said electrical power usage to the central control system,
the central control system managing the electrical power based on the electrical power meter signals.

30. The community system of claim 2 wherein the community resources include natural gas resources, the community system further comprising
meter apparatus for metering community natural gas usage and for sending meter signals indicative of said usage to the central control system,
the central control system managing the natural gas resources based on the meter signals.

31. A system for management of a plurality of community assets of a community and of unit assets of each of a plurality of individual units of a community, the system comprising
a central control system in communication with each community asset for managing each community asset,
each individual unit of the plurality of units of the community having a unit manager in communication with each unit asset for managing each unit asset,
the central control system in communication with each unit manager for selective management of each unit asset by the central control system,
a network system providing for communications between the central control system and each unit manager and providing for communications between the central control system and each community asset,
wherein the community has community resources systems,
the central control system manages the community resource systems,
wherein the community resource systems include any of power generation system, water supply system, water treatment system, and water purification system,
wherein the community assets include any of community lighting system, community facility, community pool, community recreation center, community security system, community alarm system, community heating system, community electrical power-consuming item, and community cooling system,
wherein the unit assets include any of unit lighting system, unit security system, unit alarm system, unit pool, unit cooling system, unit heating system, and unit electrical power-consuming system,
wherein managing of each community asset includes monitoring, controlling, adjusting and scheduling each community asset,
wherein the network system is any of a public switched telephone network, an Internet protocol network, a wireless network, and a point-to-point radio system,
the community resources including water resources,
water meter apparatus for metering community water usage and for sending water meter signals indicative of said community water usage to the central control system,
the central control system managing the water resources based on the water meter signals,
wherein the community resources include electrical power resources, the community system further comprising
electrical power meter apparatus for metering community electrical power usage and for sending electrical power meter signals indicative of said electrical power usage to the central control system, and
the central control system managing the electrical power based on the electrical power meter signals.
